(19) United States
(12) Patent Application Publication
(10) Pub. No.: US 2025/0371843 A1
(43) Pub. Date: Dec. 4, 2025

(54) SYSTEMS AND METHODS FOR FEW-SHOT NEW ACTION RECOGNITION

(71) Applicants: CESKE VYSOKE UCENI TECHNICKE V PRAZE, Praha (CZ); NAVER CORPORATION, Gyeonggi-do (KR); NAVER LABS CORPORATION, Gyeonggi-do (KR)

(72) Inventors: Juliette Laure Denise BERTRAND, Grenoble (FR); Ioannis KALANTIDIS, Grenoble (FR); Georgios TOLIAS, Praha (CZ)

(73) Assignees: CESKE VYSOKE UCENI TECHNICKE V PRAZE, Praha (CZ); NAVER CORPORATION, Gyeonggi-do (KR); NAVER LABS CORPORATION, Gyeonggi-do (KR)

(21) Appl. No.: 18/393,977

(22) PCT Filed: Feb. 23, 2023
(86) PCT No.: PCT/IB2023/000078

§ 371 Date: Dec. 22, 2023

(51) Int. Cl. G06V 10/74; G06F 16/73; G06V 10/776; G06V 10/82; G06V 20/40; G06V 20/56

(52) U.S. Cl. CPC G06V 10/761; G06F 16/73; G06V 10/776; G06V 10/82; G06V 20/41; G06V 20/56

(57) ABSTRACT

A method includes: (i) receiving a query video including performance of an action; (ii) receiving a predetermined number of support videos including performance of actions, respectively, the predetermined number of support videos being less than 100 support videos; (iii) determining a similarity matrix based on a comparison of temporally ordered images of the query video with temporally ordered images of one of the support videos, respectively; (iv) determining a similarity value for the one of the support videos based on the similarity matrix; (v) repeating (iii) and (iv) for each of the support videos; (vi) identifying the highest one of the similarity values and the one of the support videos associated with the highest one of the similarity values; and (vii) setting a first indicator of the action in the query video to the same as a second indicator of the action performed in the one of the support videos.

### CROSS-REFERENCE TO RELATED APPLICATION

This application is a National Stage of International Application No. PCT/FR2023/050258, filed on Feb. 23, 2023. The entire disclosure of the application referenced above is incorporated herein by reference.

### FIELD

The present disclosure relates to image and video processing and more particularly to systems and methods for recognizing new actions in video using only a limited number of training videos including the new actions.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are one type of robot and are an example of an autonomous system that is mobile and may be trained to navigate environments without colliding with objects during travel. Navigating robots may be trained in the environment in which they will operate or trained to operate regardless of environment.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants/humans from a pickup to a destination. Another example of a navigating robot is a robot used to perform one or more functions inside a residential space (e.g., a home).

Other types of robots are also available, such as residential robots configured to perform various domestic tasks, such as putting liquid in a cup, filling a coffee machine, etc.

### SUMMARY

In a feature, an action recognition system includes: an action module trained to recognize performance of predetermined actions in videos; a matrix module configured to determine similarity matrices for a predetermined number of support videos, respectively, based on comparisons of (a) temporally ordered images of a query video with (b) temporally ordered images of the support videos, respectively, the predetermined number of support videos being less than 100 support videos, the query video including performance of a new action that is not one of the predetermined actions; a similarity module including the transformer architecture and configured to determine similarity values for the support videos based on the similarity matrices determined based on the support videos, respectively, where the action module is configured to: determine which one of the support videos has the highest one of the similarity values; and set a first indicator of the action in the query video to the same as a second indicator of the new action performed in the one of the support videos having the highest similarity value.

In further features, the predetermined number of support videos is less than or equal to 5 support videos.

In further features: a first fully connected linear layer is configured to generate first vector representations of the support videos and output the first vector representations to the matrix module; and a second fully connected linear layer is configured to generate a second vector representation of the query vid and output the second vector representation to the matrix module, where the matrix module is configured to generate the similarity matrices based on the second vector representation and the first vector representations, respectively.

In further features, the similarity module includes a transformer module having the transformer architecture and configured to determine the similarity values.

In further features, the similarity module further includes a flattening module configured to convert a received similarity matrix into a vector, where the transformer module is configured to determine a similarity value based on the vector.

In further features, the flattening module is configured to convert the received similarity matrix into a vector by concatenating rows of the received similarity matrix.

In further features, the similarity module further includes an embedding module configured to embed the vector into an embedding, where the transformer module is configured to determine a similarity value based on the embedding.

In further features, the similarity module further includes a positional encoding module configured to add positional encoding to the embedding, where the transformer module is configured to determine a similarity value based on the embedding and the added positional encoding.

In a feature, a robot includes: an actuator; the action recognition system configured to recognize in video performance of the predetermined actions and performance of the new action; and a control module configured to selectively actuate the actuator in response to recognition of an action by the action module in the video.

In further features, the robot includes a camera configured to output the video, where the action recognition system is configured to receive the video from the camera.

In a feature, a robot includes: the action recognition system; and a control module configured to, in response to recognition of an action by the action module, selectively output at least one of a visual indicator and an audible indicator.

In a feature, a training system includes: the action recognition system; and a training module configured to train the action module based on minimizing a cross entropy loss.

In a feature, an action recognition system includes: an action module trained to recognize performance of predetermined actions in videos; a matrix module configured to determine a similarity matrix based on comparisons of (a) temporally ordered images of a query video with (b) temporally ordered images of a support videos, the query video including performance of a new action that is not one of the predetermined actions, and the support video including performance of the action; and a similarity module including the transformer architecture and configured to determine a similarity value for the support video based on the similarity matrix determined based on the query video and the support video, where the action module is configured to set a first indicator of the new action in the query video to the same as a second indicator of the action performed in the one of the support videos.

In a feature, an action recognition method includes: (i) receiving a query video including performance of an action; (ii) receiving a predetermined number of support videos including performance of actions, respectively, the predetermined number of support videos being less than 100 support videos; (iii) determining a similarity matrix based on a comparison of (a) temporally ordered images of the query video with (b) temporally ordered images of one of the support videos, respectively; (iv) determining a similarity value for the one of the support videos based on the similarity matrix; (v) repeating (iii) and (iv) for each of the support videos; (vi) identifying the highest one of the similarity values and the one of the support videos associated with the highest one of the similarity values; and (vii) setting a first indicator of the action in the query video to the same as a second indicator of the action performed in the one of the support videos associated with the highest one of the similarity values.

In further features, the determining the similarity value includes determining the similarity value by a module including the transformer architecture.

In further features, the predetermined number of support videos is less than or equal to 5 support videos.

In further features, the action recognition method further includes: by a first fully connected linear layer, generating first vector representations of the support videos; and by a second fully connected linear layer, generating a second vector representation of the query video, where generating the similarity matrices includes generating the similarity matrices based on the second vector representation and the first vector representations, respectively.

In further features, the action recognition method further includes converting a received similarity matrix into a vector, where the determining a similarity value includes determining a similarity value based on the vector.

In further features, the converting includes converting the received similarity matrix into a vector by concatenating rows of the received similarity matrix.

In further features, the action recognition method further includes embedding the vector into an embedding, where the determining a similarity value includes determining a similarity value based on the embedding.

In further features, the action recognition method further includes adding positional encoding to the embedding, where the determining a similarity value includes determining a similarity value based on the embedding and the added positional encoding.

In further features, the action recognition method further includes selectively actuating an actuator of a robot in response to recognition of an action in the query video.

In further features, the action recognition method further includes receiving the query video from a camera of the robot.

In further features, the action recognition method further includes, in response to recognition of an action in the query video, selectively outputting at least one of a visual indicator and an audible indicator.

In a feature, an action recognition method includes: by an action module trained to recognize performance of predetermined actions in videos, recognizing performance of the predetermined actions in videos; determining a similarity matrix based on comparisons of (a) temporally ordered images of a query video with (b) temporally ordered images of a support videos, the query video including performance of a new action that is not one of the predetermined actions, and the support video including performance of the action; by a similarity module including the transformer architecture, determining a similarity value for the support video based on the similarity matrix determined based on the query video and the support video; and by the action module, setting a first indicator of the new action in the query video to the same as a second indicator of the action performed in the one of the support videos.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1 and 2 are functional block diagrams of example robots;

FIG. 3 includes a functional block diagram of an example training system;

FIG. 4 includes a functional block diagram including an example implementation of an action recognition module;

FIG. 5 is a functional block diagram of an example implementation of a similarity module having the transformer architecture

FIG. 6 is a functional block diagram of an example implementation of a transformer module;

FIG. 7 includes a functional block diagram of an example implementation of a multi-head attention module;

FIG. 8 includes a functional block diagram of an example implementation of a scaled dot-product attention module of a multi-head attention module;

FIG. 9 is a flowchart depicting an example method of learning to recognize performance of a new action in a query video using only a limited number of support videos; and

FIGS. 10-12 include example images of performance of actions.

In the drawings, reference numbers may be reused to identify similar and/or identical elements.

### DETAILED DESCRIPTION

A robot may include a camera. Images/video from the camera and measurements from other sensors of the robot can be used to control actuation of the robot, such as propulsion, actuation of one or more arms, and/or actuation of a gripper. Video from the camera can also be used to recognize the performance of various types of actions performed in the video, such as actions performed by animals (e.g., humans). The robot is trained to recognize performance of predetermined training actions.

The present application involves a recognition module of the robot being configured to learn to recognize performance of a new action (not included in the predetermined training actions) using few (e.g., 1-5) videos including the new action being performed. The recognition module does this using the transformer architecture, discussed further below, based on temporal similarity matrix. The temporal similarity matrix may be a matrix including pairwise similarities between sequences of clip (from video) features. The pairwise matching performs better than other approaches, such as parametric classifiers, while learning to perform new actions on a minimum number of video clips including performance of the new actions.

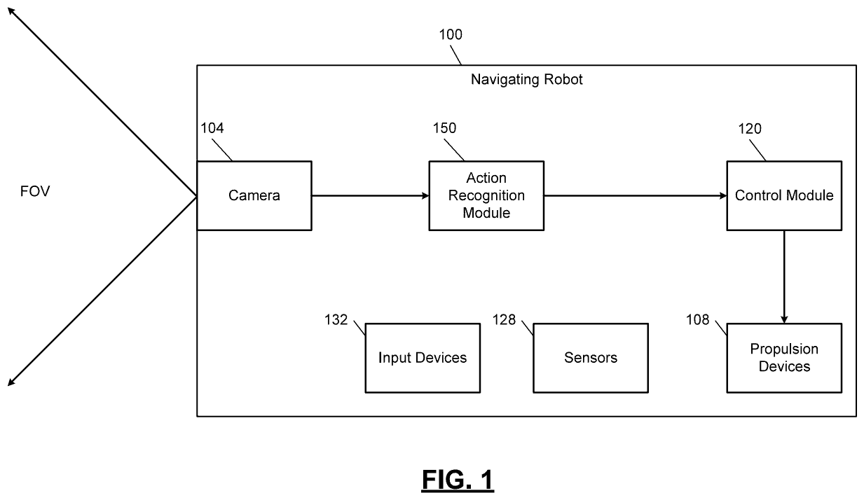

FIG. 1 is a functional block diagram of an example implementation of a navigating robot 100. The navigating robot 100 is a vehicle and is mobile. The navigating robot 100 includes a camera 104 that captures images within a predetermined field of view (FOV). The predetermined FOV may be less than or equal to 360 degrees around the navigating robot 100. The operating environment of the navigating robot 100 may be an indoor space (e.g., a building), an outdoor space, or both indoor and outdoor spaces.

The camera 104 may be, for example, a grayscale camera, a red, green, blue (RGB) camera, or another suitable type of camera. The camera 104 may or may not capture depth (D) information, such as in the example of a grayscale-D camera or a RGB-D camera. The camera 104 may be fixed to the navigating robot 100 such that the orientation of the camera 104 (and the FOV) relative to the navigating robot 100 remains constant. The camera 104 may update (capture images) at a predetermined frequency, such as 60 hertz (Hz), 120 Hz, or another suitable frequency.

An action recognition module 150 recognizes actions performed (e.g., performed by animals, such as humans) in clips of video from the camera 104. The action recognition module 150 is trained to recognize performance of predetermined training actions. As discussed further below, the action recognition module 150 is also configured to recognize performance of a new action using only a few (e.g., 1-5) videos including the new action being performed.

The navigating robot 100 may include one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly. The robot 100 is powered, such as via an internal battery and/or via an external power source, such as wirelessly (e.g., inductively).

While the example of a navigating robot is provided, the present application is also applicable to other types of robots with a camera.

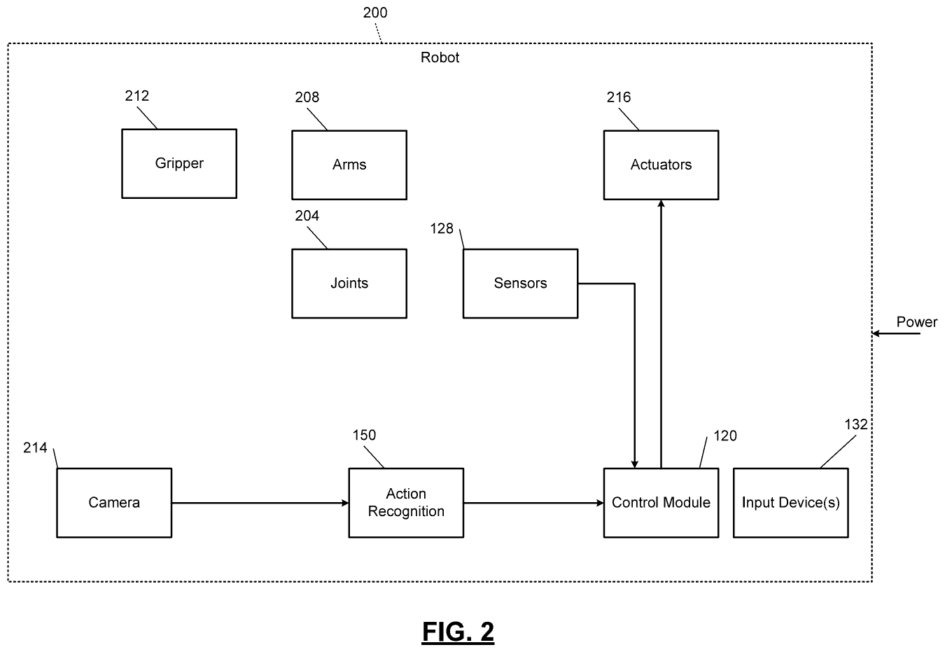

For example, FIG. 2 includes a functional block diagram of an example robot 200. The robot 200 may be stationary or mobile. The robot 200 may be, for example, a 5 degree of freedom (DoF) robot, a 6 DoF robot, a 7 DoF robot, an 8 DoF robot, or have another number of degrees of freedom. In various implementations, the robot 200 may include the Panda Robotic Arm by Franka Emika, the mini Cheetah robot, or another suitable type of robot.

The robot 200 is powered, such as via an internal battery and/or via an external power source, such as alternating current (AC) power. AC power may be received via an outlet, a direct connection, etc. In various implementations, the robot 200 may receive power wirelessly, such as inductively.

The robot 200 includes a plurality of joints 204 and arms 208. Each arm may be connected between two joints. Each joint may introduce a degree of freedom of movement of a (multi fingered) gripper 212 of the robot 200. The robot 200 includes actuators 216 that actuate the arms 208 and the gripper 212. The actuators 216 may include, for example, electric motors and other types of actuation devices.

In the example of FIG. 1, a control module 120 controls actuation of the propulsion devices 108. In the example of FIG. 2, the control module 120 controls the actuators 216 and therefore the actuation (movement, articulation, actuation of the gripper 212, etc.) of the robot 200.

The control module 120 may include a planner module configured to plan movement of the robot 200 to perform one or more different tasks. An example of a task includes moving to and grasping and moving an object. The present application, however, is also applicable to other tasks, such as navigating from a first location to a second location while avoiding objects and other tasks. The control module 120 may, for example, control the application of power to the actuators 216 to control actuation and movement. Actuation of the actuators 216, actuation of the gripper 212, and actuation of the propulsion devices 108 will generally be referred to as actuation of the robot.

The robot 200 also includes a camera 214 that captures images within a predetermined field of view (FOV). The predetermined FOV may be less than or equal to 360 degrees around the robot 200. The operating environment of the robot 200 may be an indoor space (e.g., a building), an outdoor space, or both indoor and outdoor spaces.

The camera 214 may be, for example, a grayscale camera, a red, green, blue (RGB) camera, or another suitable type of camera. The camera 214 may or may not capture depth (D) information, such as in the example of a grayscale-D camera or a RGB-D camera. The camera 214 may be fixed to the robot 200 such that the orientation of the camera 214 (and the FOV) relative to the robot 200 remains constant. The camera 214 may update (capture images) at a predetermined frequency, such as 60 hertz (Hz), 120 Hz, or another suitable frequency.

The control module 120 controls actuation of the robot based on one or more images from the camera. The control module 120 may control actuation additionally or alternatively based on measurements from one or more sensors 128 and/or one or more input devices 132. Examples of sensors include position sensors, temperature sensors, location sensors, light sensors, rain sensors, force sensors, torque sensors, etc. Examples of input devices include touchscreen displays, joysticks, trackballs, pointer devices (e.g., mouse), keyboards, steering wheels, pedals, and/or one or more other suitable types of input devices.

The control module 120 may control actuation of the robot additionally or alternatively based on one or more actions recognized by the action recognition module 150. The control module 120 may additionally or alternatively take one or more other actions when performance of an action is recognized by the action recognition module 150. For example, the control module 120 may actuate the robot according to one or more predetermined movements when one or more actions are recognized. Additionally or alternatively, the control module 120 may output an alarm (e.g., audibly via a speaker, visually via a light or display, etc.) when one or more actions are recognized. The control module 120 may additionally or alternatively take one or more other actions when performance of one or more actions are recognized by the action recognition module.

Described herein is a matching-based method for few-shot action recognition based on a transformer module. Few-shot action recognition (or more generally few-shot learning) involves learning using a reduced training set. The size that a training set (i.e., few-shot set) used in few-shot learning may be reduced depends on a number of factors such as quality and availability of training data samples. For example, in some instances a few-shot training set may include 10 or less data samples (e.g., support videos), in other examples, a few-shot training set may include 100 or less data samples.

The action recognition module 150 may sample multiple, temporally ordered clips per video and works with a temporal similarity matrix, a matrix of pairwise similarities between sequences of clip features. When starting from strong representations, pairwise matching-based approaches that act as k-nearest-neighbor classifiers outperform parametric classifiers, especially for the case of one-shot learning, while enjoying training-free generalization to novel action classes. The choice of matching strategy may make little difference.

Although temporal matching approaches may give best results, non-temporal methods may work almost as well. A factor affecting performance may be better representations. High levels of accuracy can be achieved by non-temporal pairwise approaches which may be invariant to permutations in the ordering of clips.

In various implementations, a transformer module may be used and directly consume the similarity matrix. This is different than a transformer module that uses features from images. This may provide a high level of performance on both benchmark tests while it can be extended to perform video to video-set matching and achieve extra gains when more than one video per class are available. Additionally, the described transformer-based approach may allow for direct validation of the impact of temporal information in the matching.

Herein, videos may be referred to as examples, and actions may be referred to as classes. There are three datasets, namely, external set, meta-train set, and meta-test set, and three corresponding learning stages, namely, pre-training, training, and fine-tuning. While an example of training is provided, the present application is also applicable to other types of training.

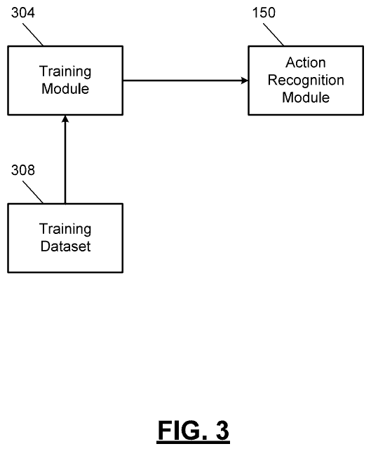

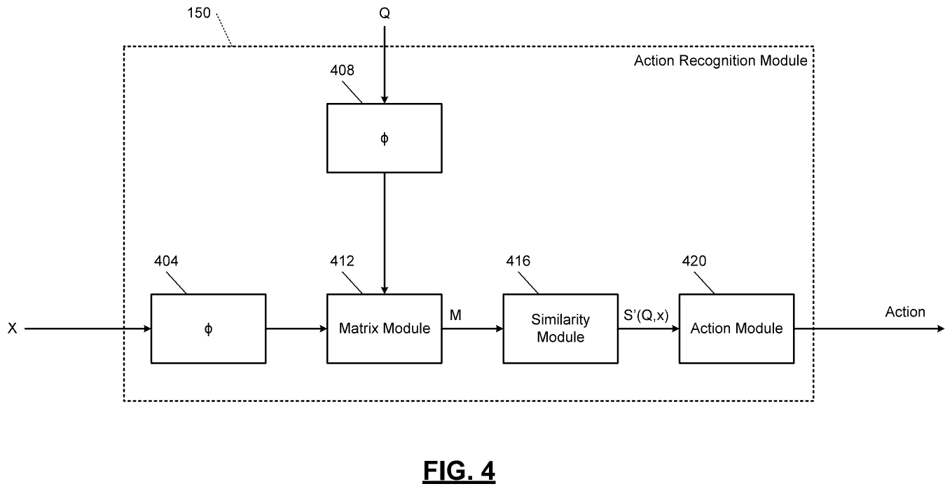

FIG. 3 is a functional block diagram of an example training system. FIG. 4 is a functional block diagram including an example implementation of the action recognition module 150. A training module 304 trains the action recognition module 150 using a training dataset 308. The training is discussed further below.

The action recognition module 150 includes fully connected linear layers (ϕ) 404 and 408. The fully connected linear layer 404 generates vector representations of a small predetermined number (e.g., a few-shot set, such as 1-5, less than or equal to 100, 75, 50, 25, or 10) support videos (X) demonstrating performance of an action for the action recognition module 150 to learn to recognize. The fully connected linear layer 404 reduces dimensionality of the support videos.

The fully connected linear layer 408 generates a vector representation of a query video (Q) demonstrating performance of the action for the action recognition module 150 to learn to recognize. The fully connected linear layer 408 reduces dimensionality of the query video. The query video may be captured, for example, using the camera of the robot, retrieved via a network, or obtained in another suitable manner.

A matrix module 412 generates a temporal similarity matrix M for each pair including one of the support videos (X) and the query video (Q). Generation of the temporal similarity matrices is discussed further below.

A similarity module 416 includes the transformer architecture and generates a similarity value (s′) for one of the support videos (X) based on the temporal similarity matrix (M) for that one of the support videos (X). Transformer architecture as used herein is described in Ashish Vaswani, Noam Shazeer, Niki Parmar, Jakob Uszkoreit, Llion Jones, Aidan N Gomez, [symbol] ukasz Kaiser, and Illia Polosukhin, “Attention is all you need”, In I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety. Additional information regarding the transformer architecture can be found in U.S. Pat. No. 10,452,978, which is incorporated herein in its entirety. The transformer architecture is one way to implement a self-attention mechanism, but the present application is also applicable to the use of other types of attention mechanisms.

An action module 420 determines a class for the action performed in the query video (Q) based on the similarity values (S′). For example, the action module 420 may identify a highest one of the similarity values (S′) generated based on the similarity matrix (M) for one of the support videos (x) and the query video (Q). The action module 420 may set the class for the action performed in the query video to the class (action) of that one of the support videos (x). In other words, the action module 420 may set the class for the action performed in the query video (Q) to the same class as the class of the one of the support videos with the highest similarity value (S′).

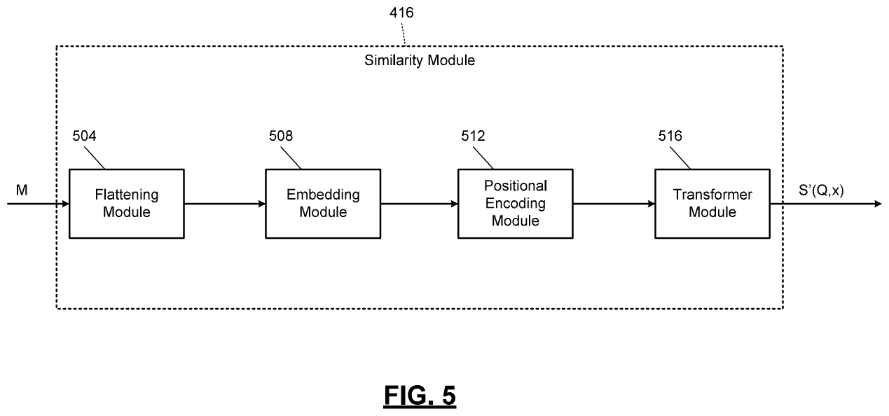

FIG. 5 is a functional block diagram of an example implementation of the similarity module 416. The temporal similarity matrices (for the respective support videos x) are input to the similarity module 416. A flattening module 504 flattens an input temporal similarity matrix, for example, by converting the temporal similarity matrix into a vector (a similarity vector), such as row-wise or column-wise. The flattening module 504 does this for each input temporal similarity matrix.

An embedding module 508 embeds a similarity vector into a higher dimension embedding. The embedding module 508 does this for each similarity vector.

A positional encoding module 512 positionally encodes a received embedding into an encoding. The positional encoding module 512 may also add a class token for the class of the respective support video x to the encoding (resulting from the similarity matrix M). The positional encoding module 512 does this for each embedding.

A transformer module 516 has the transformer architecture and determines the similarity value (S′) for a pair (support video x and query video Q) based on the encoding generated based on the temporal similarity matrix M for that pair. The transformer module 516 does this for each encoding.

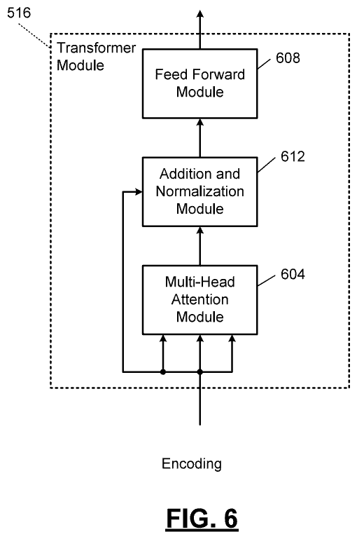

FIG. 6 is a functional block diagram of an example implementation of the transformer module 516. The transformer module 516 includes a multi-headed attention layer or module including h “heads” which are computed in parallel. Each of the heads performs three linear projections called (1) the key K, (2) the query Q, and (3) the value V. The three transformations of the individual set of input features are used to compute a contextualized representation of each of the inputs. The scaled-dot attention applied on each head independently. Each head aims at learning different types of relationships among the inputs and transforming them. Then, the outputs of each layer are concatenated as head {1,h} and are linearly projected to obtain a contextualized representation of each input, merging all information independently accumulated in each head into M.

The heads of the transformer architecture allow for discovery of multiple relationships between the input sequences.

The transformer module 516 may include a stack of N=6 identical layers. Each layer may have two sub-layers. The first sub-layer may be a multi-head attention mechanism (module) 604 (e.g., self-attention and/or cross-attention), and the second may be a position wise fully connected feed-forward network (module) 608. Addition and normalization may be performed on the output of the multi-head attention module 604 by an addition and normalization module 612. Concatenation may also be performed by the addition and normalization module 612. Residual connections may be used around each of the two sub-layers, followed by layer normalization.

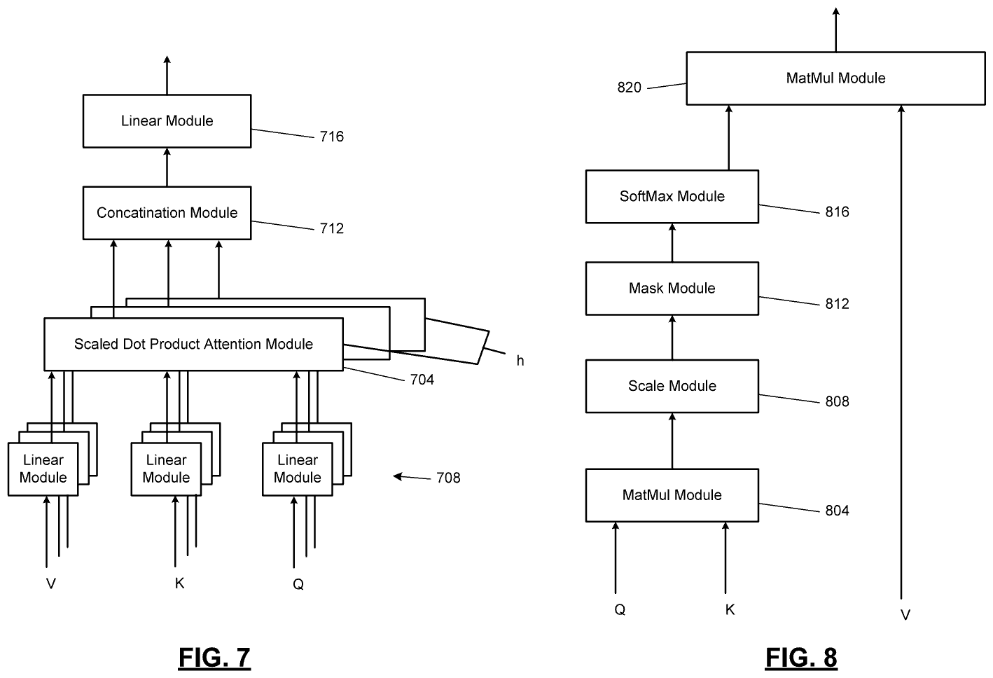

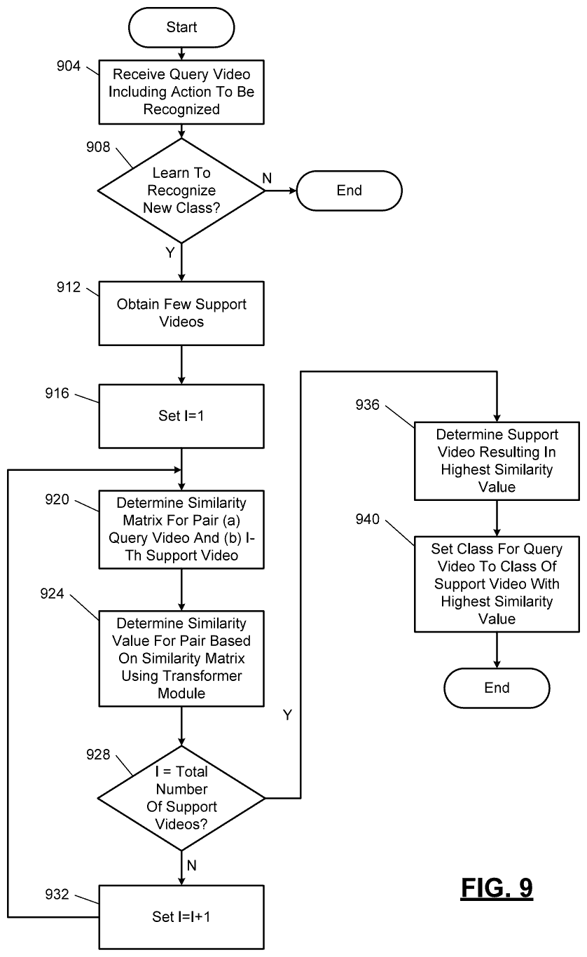

FIG. 7 includes a functional block diagram of an example implementation of the multi-head attention module 604. FIG. 8 includes a functional block diagram of an example implementation of a scaled dot-product attention module 704 of the multi-head attention module 604.

Regarding attention (performed by the multi-head attention module 604), an attention function may function by mapping a query and a set of key-value pairs to an output, where the query, keys, values, and output are all vectors. The output may be computed as a weighted sum of the values, where the weight assigned to each value is computed by a compatibility function of the query with the corresponding key.

In the scaled dot-product attention module, the input includes queries and keys of dimension dk, and values of dimension dv. The scaled dot-product attention module 704 computes dot products of the query with all keys, divides each by √dₖ, and applies a softmax function to obtain weights on the values.

The scaled dot-product attention module 704 may compute the attention function on a set of queries simultaneously arranged in Q. The keys and values may also be held in matrices K and V. The scaled dot-product attention module 704 may compute the matrix of outputs based on or using the equation:

$$Attention ( Q , VK , V ) = softmax ( \frac{{QK}^{T}}{\sqrt{{d}_{k}}} ) V .$$

The attention function may be, for example, additive attention or dot-product (multiplicative) attention. Dot-product attention may be used in addition to scaling using a scaling factor of

$$\frac{1}{\sqrt{{d}_{k}}} .$$

Additive attention computes a compatibility function using a feed-forward network with a single hidden layer. Dot-product attention may be faster and more space-efficient than additive attention.

Instead of performing a single attention function with d-dimensional keys, values and queries, the multi-head attention module 604 may linearly project the queries, keys, and values h times with different, learned linear projections to dₖ, d_{q} and dᵥ dimensions, respectively, using linear modules 708. On each of the projected versions of queries, keys, and values the attention function may be performed in parallel, yielding dv-dimensional output values. These may be concatenated and projected again, resulting in the final values, by a concatenation module 712 and a linear module 716 as shown. Multi-head attention may allow for joint attention to information from different locations.

As shown in FIG. 8, a MatMul module 804 generates an output based on the query Q and key K values using the MatMul function. A scale module 808 may scale the output of the MatMul module 804 by one or more predetermined scalar values. A mask module 812 may mask one or more portions of the output of the scale module 808 to produce an output. In various implementations, the mask module 812 may be omitted.

A SoftMax module 816 may apply the softmax function to the output of the mask module 812. A MatMul module 820 generates an output to the concatenation module 712 based on the output of the SoftMax module 816 and the value V using the MatMul function. Additional information regarding the transformer architecture can be found in U.S. Pat. No. 10,452,978, which is incorporated herein in its entirety.

Regarding training of the action recognition module 150, during a pre-training stage, a large external set of examples is used by the training module 304 to train a representation network of the action recognition module 150. During a training stage, after the pre-training stage, a meta-train set is used to train the action module 420 of the action recognition module 150. It contains examples that are all labeled. In other words, the meta-train set includes examples and respective labels of the actions performed in the examples, respectively.

The training module 304 may test the action recognition module 150 after the training stage using a meta-test set. The classes (actions performed) of the meta-train and meta-test sets may be non-overlapping and may include base and new classes, respectively. The meta-test set includes query and support examples, where labels of support examples may be provided, while labels of query examples are unknown. Only k labeled examples per class are available in the meta-test, where k is an integer greater than zero and may be for example 1 to 5 or less than or equal to 10.

During an optional fine-tuning stage, support examples of the meta-test set are used to fine tune the action module on the new classes. An episode may be the combination of an instantiation of such a meta-test set with k support examples per class, for a fixed set of classes, and a set of query examples. A meta-val set may be used for validation.

The type of training and fine-tuning used by the training module 304 may be set based on the classification approach. As a first example, models that involve a parametric classifier (parametric classifier modules) may use meta-train examples to train the action module and backbone, and involve fine-tuning of a newly initialized action module for every episode of the meta-test set. During fine-tuning, the backbone may be frozen by the training module 304 as it may overfit to the few examples. A second example includes models that perform matching-based approaches that do not use a parametric classifier. Instead, these models perform pair-wise matching between the query and the support examples of each class to obtain class probabilities. Inference is performed in a k-nearest-neighbor classification manner were k is an integer greater than or equal to 1. These models may be referred to as non-parametric and as matching based. During training, the matching process and optionally the backbone are optimized by the training module 304 with episodes sampled from the meta-train set. These episodes may imitate the episodes of the meta-test set. The fine-tuning stage is optional, and may not be performed in any matching-based prior work. The only process required before inference may be extract features from the support examples using the backbone model.

A clip xi is a sequence of consecutive video frames. The middle frame is at time i within the video, and is represented by feature vector xᵢεR_{d}, also called a feature for brevity. It is extracted by a deep backbone for videos of the action recognition module 150, which may also be called a feature extractor. The backbone is denoted by b and takes a clip xᵢ as input and maps it to a d-dimensional vector xᵢ=b(xᵢ). The feature extractor may be, for example, the R(2+1)D backbone architecture as described in Tran, D., et al., A Closer Look at Spatiotemporal Convolutions for Action Recognition, in CVPR, 2018, and Xian, et al., Generalized Few-Shot Video Classification With Video Retrieval and Feature Generation, IEEE, TPAMI, 2021, the entire disclosures of which are incorporated herein. This architecture uses separate spatio-temporal convolutions that are not only more efficient but also more effective. The feature extractor (module) generates the inputs to the layers 404 and 408. Consider a video X to be represented as X={xᵢ}, i.e. a set of features from clips that are sampled uniformly over the temporal dimension with possible overlap.

An image backbone (ResNet), may be used. Frames, instead of clips, may be uniformly sampled and a feature vector per frame may be extracted, while each vector is associated with the temporal position of the frame. As with the video backbone, a video is represented by a set of features from sampled frames. All temporal matching approaches discussed herein can be used with either backbone. R(2+1)D captures temporal information already in the feature vectors and achieves higher performance.

A Two-stage Learning (TSL) approach may be used which includes using a deep network classifier on top of the R(2+1)D backbone. This may include a linear classifier with soft-max is added to the output of the backbone as h: [symbol] ^{d}→ [symbol] ^{c}, where C is the number of classes which is different for the different training stages.

Optimization may be performed with cross-entropy loss for classification, denoted by L_{cls}. During training the vector of class probabilities is given by h(xᵢ), then fed to the loss for each xᵢ∈X. The backbone and classifier may be jointly trained by the training module 304 during this stage, with C equal to the number of all classes in the meta-train set. During fine-tuning, the same process may be performed by the training module 304 but on a newly initialized linear layer for the novel classes, while the backbone remains frozen, and C is equal to the number of classes per meta-test episode.

Inference may be performed by sum-pooling of the classifier output across clips, i.e., Σx_{i∈X}h(xᵢ).

For matching based approaches, the representation learning process of TSL may be used for training matching-based methods. Specifically, we follow the pre-training and training stages described in Xian, Y., to learn the backbone parameters, freeze it, and treat the resulting model as a feature extractor. We then use those features to train matching-based methods. This process can be seen as an extra training stage for matching-based methods, in which the matching parameters are learned in a meta-test agnostic way. Unlike TSL that involves training a classifier at every meta-testing episode, matching-based approaches may involve no learning or adaptation. Instead, pairwise matching is computed between the query and each of the support videos.

Regarding the temporal similarity matrices, consider a query video Q={qᵢ}, and for simplicity assume that |Q|=|X|=n and that n does not vary across video pairs. The temporal similarity matrix generated for the ordered video pair (Q, X) may be denoted by M∈ [symbol] ^{n×n} with elements mᵢⱼ=ϕ(xᵢ)^{T}ϕ(qⱼ), where ϕ: [symbol] → [symbol] ^{D} is a learnable projection layer. Function ϕ(⋅) may include a linear layer, layer-normalization, and [symbol] 2 normalization, such as to guarantee bounded similarity values mᵢⱼ. For brevity, mᵢⱼ may also be denoted by mₜ, with t=(i, j) being a temporal position pair.

Each element of matrix M can be considered a temporal correspondence between two clips from the two videos of the pair. Scalar similarity mt may be considered a confidence value for t being a true correspondence between the pair, i.e., formed between clips of the same action part.

Regarding matching, matching approaches may infer video-to-video similarity s′(Q, X) based on the temporal similarity matrix M, s′(Q, X)=s(M). This is performed by function s: [symbol] ^{n×n}→ [symbol] that takes as input the temporal similarity matrix and estimates a (e.g., scalar) similarity value. This similarity may (not) be high if the two videos (do not) depict the same action. Such estimation may only depend on the strength and, optionally, the position of the similarities in the input matrix and may not depend on the features that are cross-matched.

Function s(⋅) may perform temporal matching in a way that does not directly depend on the features but on pairwise similarity of features. The matching process can be either handcrafted or include learnable parts as well. If positions are not taken into account, temporal information may not be captured in the matching, and may only be captured by the features. In that case, the matching process itself may be time-invariant. Described herein include systems and methods that include elements of M as input tokens to a transformer module and are able to perform matching either in a time-dependent or in a time-invariant way.

Regarding the transformer module 516, the elements of M may be considered a set of scalar similarities {mₜ ∈ [symbol] , t∈[1, . . . , n²]}, where each element of the set is associated with position pair t. Scalar similarity mt is mapped to a high dimensional vector by a learnable mapping f: [symbol] → [symbol] ^{z}. Position t is mapped to a high dimensional vector by p: [symbol] → [symbol] ^{z} in the same way as with positional encodings. For example, fixed positional embeddings may be used with cosine and sine encoding. Similarity and position embeddings may be summed to form a combined embedding. The combined embeddings are the input tokens of the transformer module 516. The positional encoding module 512 may additionally append a learnable matching token m∈ [symbol] ^{z} resulting into n²+1 tokens in total.

The transformer module 516 may include a self-attention mechanism followed by a feed-forward network, such as a Multi-Layer-Perceptron (MLP) network. An encoder-decoder architecture may be used, and the encoder may include a single transformer layer, while the decoder may include an MLP network that has dimensionality equal to 1 for its output tokens. The scalar output corresponding to the matching token is what is used as the video-to-video similarity denoted by

$$s ( M ) = T ( \{ f ( {m}_{t} ) + p ( t ) \} ⋃ m ) ,$$

where T(⋅) is used to represent the overall transformer module. The learnable parameters are those of the encoder and decoder.

The similarity module 416 may enable or disable the use of temporal information in the TST by using positional embeddings or not. Without temporal information, the present disclosure accounts for processing over a set of similarity correspondences, where each correspondence is represented solely by its strength. The similarity module 416 makes no assumptions on the structure of M. Other architectures may assume perfect alignment, one-to-one matching, and global alignment and/or local temporal context. The similarity module 416 of the present application captures global temporal context.

In the single-shot example, i.e., k=1, the video-to-class similarity for video Q and class c may be equivalent to the video-to-video similarity s′(Q, c)=s′(Q, X), with c_{X}=c, where cx is the class of support example X. Multi-shot may be performed by matching the query separately with each of the k support videos and averaging the similarities, i.e., s′(Q, c)=s′(Q, X)/k, with X={X:c_{X}=c}.

Joint matching is possible for the architecture described herein due to the use of the transformer module 516, such as follows. The similarity module 416 creates the union of all elements from temporal similarity matrices between the query and all support examples X, obtains similarity embeddings, and sums with the corresponding positional embeddings. The same n² embeddings may be re-used for all support examples. The matching token may be appended and all tokens may be given as input to the transformer module 516, while the output corresponding to the matching token is used as video-to-class similarity.

The training module 304 trains the action recognition module 150 with the use of episodes from the meta-train set. A cross-entropy loss may be used (e.g., minimized) by the training module 304 after applying soft-max on top of the video-to-class similarities. This loss may be denoted Lₚₐᵢᵣ due to the pair-wise nature of the approach described herein involving pair-wise similarity of the query with support examples. Note that this is a second round of the training. The training may be performed with and without the projection ϕ(⋅), such as to explore its impact. When not used, the approach may be similar or equivalent to identity mapping and [symbol] 2 normalization. In various implementations, the training module 304 may not perform the fine-tuning stage.

Generally speaking, the action recognition module 150 is configured to learn temporal matching between a query video including an action to be learned to recognize and support videos. A number of N temporally ordered clips may be extracted from each video and encoded with an encoder module. The N clips from a pair of videos are all matched with each other and the similarities are reflected in the temporal similarity matrix generated for the pair. A transformer module outputs a pairwise similarity value for the pair based on the temporal similarity matrix for the pair (e.g., after the vectorization, embedding, encoding, etc.). In various implementations, a positional encoding vector may be added to the input to the transformer module. The action recognition module 150 may be trained with a pairwise loss using episodes.

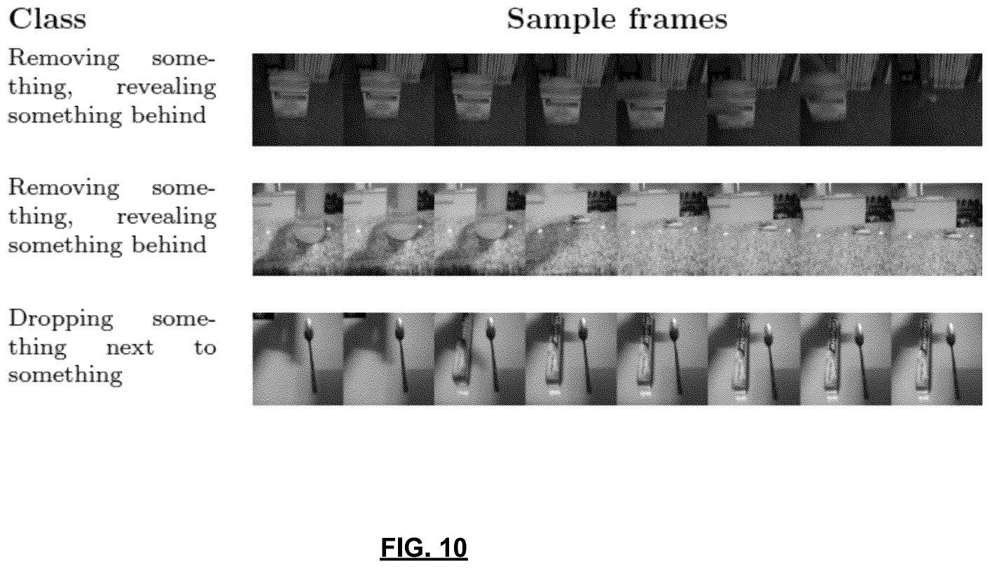

FIG. 9 is a flowchart depicting an example method of learning to recognize performance of a new action in a query video using only a few (e.g., 1-5 or less than 10) support videos. Control begins with 904 where the action recognition module 150 receives a query video including an action being performed.

At 908, the action module 420 may determine whether the action being performed in the query video should be learned. For example, the action module 420 may determine to learn to recognize the action performed in the query video when all of the similarity values between the query image and videos of actions which the action module 420 is already configured to recognize are less than a predetermined value (do not belong to a predetermined class). If 908 is true, control continues with 912. If 908 is false, control may end.

At 912, the action recognition module 150 receives a small number (e.g., 1-5, less than 10) of support videos. At 916, the action module 420 sets a counter value (I) equal to 1. At 920, the matrix module 412 determines the temporal similarity matrix M for the i-th one of the support videos and the query video based on the i-th one of the support videos and the query video.

At 924, the similarity module 416 (the transformer module 516) determines the similarity value for the i-th one of the support videos and the query video based on the temporal similarity matrix M determined for the i-th one of the support videos and the query video. At 928, the action module 420 may determine whether the counter value I is equal to the total number of support videos to be compared with the query video. If 928 is true, control continues with 936. If 928 is false, the action module 420 may increment the counter value (e.g., set I=I+1) at 932, and return to 920 to determine the temporal similarity matrix and the similarity value for the next pair of support video and query video.

At 936, the action module 420 identifies the one of the support videos that resulted in the highest similarity value. At 940, the action module 420 sets the class for the query video to the same class (action) as the one of the support videos that resulted in the highest similarity value. The action recognition module 150 may then be able to recognize performance of the action in query videos in the future, which include both the new class identified at 908 and those predetermined classes known at 908. While control is shown as ending, control may return to 904.

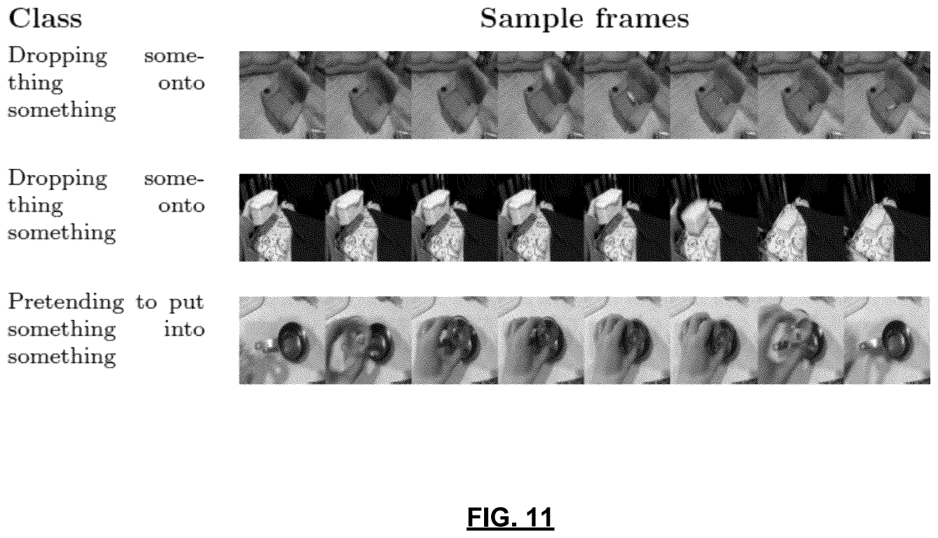

FIG. 10 includes example images of performance of actions. The top two rows include images from video illustrating different instances of performing the same action, that being removing something and revealing something that is located behind the thing removed. The bottom row includes images from video illustrating performance of a different action than the top two rows, the bottom row illustrating dropping something next to something else. Since the top two rows illustrate performance of the same action, the similarity value determined based on the videos of the top two rows would be higher than (a) the similarity value determined based on the videos of the top and bottom rows and (b) the similarity value determined based on the videos of the bottom two rows.

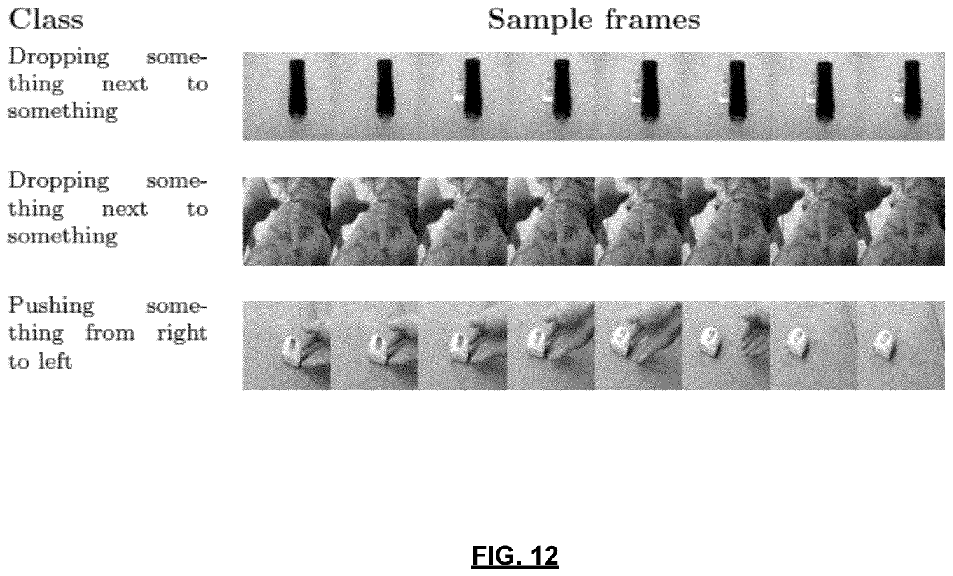

FIG. 11 includes example images of performance of actions. The top two rows include images from video illustrating different instances of performing the same action, that being dropping something onto something. The bottom row includes images from video illustrating performance of a different action than the top two rows, the bottom row illustrating pretending to put something into something. Since the top two rows illustrate performance of the same action, the similarity value determined based on the videos of the top two rows would be higher than (a) the similarity value determined based on the videos of the top and bottom rows and (b) the similarity value determined based on the videos of the bottom two rows.

FIG. 12 includes example images of performance of actions. The top two rows include images from video illustrating different instances of performing the same action, that being dropping something onto something. The bottom row includes images from video illustrating performance of a different action than the top two rows, the bottom row illustrating pretending to put something into something. Since the top two rows illustrate performance of the same action, the similarity value determined based on the videos of the top two rows would be higher than (a) the similarity value determined based on the videos of the top and bottom rows and (b) the similarity value determined based on the videos of the bottom two rows.

While the example of few shot action recognition is provided, the present application is also applicable to other applications. The output of the similarity module is a single similarity value between 2 videos. The two videos are represented by matrix M (output of the matrix module) which is the input to the similarity module. This can be useful for other tasks where similarity is useful, such as video retrieval involving searching with one video to find the similar videos in a large video collection. As another example, the present application may also be applicable to other video action recognition. The present application may also be applicable to image to image similarity being the output of the similarity module. In this example, each image region may be represented by a vector (e.g., instead of one vector per frame in the case of video) and matrix M (input to the similarity module) compares all regions of two images with each other. The positional encoding then encodes region centers, instead of time of the frame. This may be used, for example, for few shot image object recognition and other applications. In various implementations, regions can be used for video frames. In this example, a more detailed matching between two videos may be used. Matrix M may compare all regions from all frames. Positional encodings may encode regions centers and time of the frame.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An action recognition system comprising:
an action module trained to recognize performance of predetermined actions in videos;
a matrix module configured to determine similarity matrices for a predetermined number of support videos, respectively, based on comparisons of (a) temporally ordered images of a query video with (b) temporally ordered images of the support videos, respectively,
the predetermined number of support videos being less than 100 support videos,
the query video including performance of a new action that is not one of the predetermined actions;
a similarity module including the transformer architecture and configured to determine similarity values for the support videos based on the similarity matrices determined based on the support videos, respectively,
wherein the action module is configured to:
determine which one of the support videos has the highest one of the similarity values; and
set a first indicator of the action in the query video to the same as a second indicator of the new action performed in the one of the support videos having the highest similarity value.

2. The action recognition system of claim 1 wherein the predetermined number of support videos is less than or equal to 5 support videos.

3. The action recognition system of claim 1 further comprising:
a first fully connected linear layer configured to generate first vector representations of the support videos and output the first vector representations to the matrix module; and
a second fully connected linear layer configured to generate a second vector representation of the query vid and output the second vector representation to the matrix module,
wherein the matrix module is configured to generate the similarity matrices based on the second vector representation and the first vector representations, respectively.

4. The action recognition system of claim 1 wherein the similarity module includes a transformer module having the transformer architecture and configured to determine the similarity values.

5. The action recognition system of claim 4 wherein the similarity module further includes a flattening module configured to convert a received similarity matrix into a vector,
wherein the transformer module is configured to determine a similarity value based on the vector.

6. The action recognition system of claim 5 wherein the flattening module is configured to convert the received similarity matrix into a vector by concatenating rows of the received similarity matrix.

7. The action recognition system of claim 4 wherein the similarity module further includes an embedding module configured to embed the vector into an embedding,
wherein the transformer module is configured to determine a similarity value based on the embedding.

8. The action recognition system of claim 7 wherein the similarity module further includes a positional encoding module configured to add positional encoding to the embedding,
wherein the transformer module is configured to determine a similarity value based on the embedding and the added positional encoding.

9. A robot including:
an actuator;
the action recognition system of claim 1 configured to recognize in video performance of the predetermined actions and performance of the new action; and
a control module configured to selectively actuate the actuator in response to recognition of an action by the action module in the video.

10. The robot of claim 9 further comprising a camera configured to output the video,
wherein the action recognition system is configured to receive the video from the camera.

11. A robot including:
the action recognition system of claim 1; and
a control module configured to, in response to recognition of an action by the action module, selectively output at least one of a visual indicator and an audible indicator.

12. A training system comprising:
the action recognition system of claim 1; and
a training module configured to train the action module based on minimizing a cross entropy loss.

13. An action recognition system comprising:
an action module trained to recognize performance of predetermined actions in videos;
a matrix module configured to determine a similarity matrix based on comparisons of (a) temporally ordered images of a query video with (b) temporally ordered images of a support videos,
the query video including performance of a new action that is not one of the predetermined actions, and
the support video including performance of the action; and
a similarity module including the transformer architecture and configured to determine a similarity value for the support video based on the similarity matrix determined based on the query video and the support video,
wherein the action module is configured to set a first indicator of the new action in the query video to the same as a second indicator of the action performed in the one of the support videos.

14. An action recognition method comprising:
(i) receiving a query video including performance of an action;
(ii) receiving a predetermined number of support videos including performance of actions, respectively, the predetermined number of support videos being less than 100 support videos;
(iii) determining a similarity matrix based on a comparison of (a) temporally ordered images of the query video with (b) temporally ordered images of one of the support videos, respectively;
(iv) determining a similarity value for the one of the support videos based on the similarity matrix;
(v) repeating (iii) and (iv) for each of the support videos;
(vi) identifying the highest one of the similarity values and the one of the support videos associated with the highest one of the similarity values; and
(vii) setting a first indicator of the action in the query video to the same as a second indicator of the action performed in the one of the support videos associated with the highest one of the similarity values.

15. The action recognition method of claim 14 wherein the determining the similarity value includes determining the similarity value by a module including the transformer architecture.

16. The action recognition method of claim 14 wherein the predetermined number of support videos is less than or equal to 5 support videos.

17. The action recognition method of claim 14 further comprising:
by a first fully connected linear layer, generating first vector representations of the support videos; and
by a second fully connected linear layer, generating a second vector representation of the query video,
wherein generating the similarity matrices includes generating the similarity matrices based on the second vector representation and the first vector representations, respectively.

18. The action recognition method of claim 14 further comprising converting a received similarity matrix into a vector,
wherein the determining a similarity value includes determining a similarity value based on the vector.

19. The action recognition method of claim 18 wherein the converting includes converting the received similarity matrix into a vector by concatenating rows of the received similarity matrix.

20. The action recognition method of claim 18 further comprising embedding the vector into an embedding,
wherein the determining a similarity value includes determining a similarity value based on the embedding.

21. The action recognition method of claim 20 further comprising adding positional encoding to the embedding,
wherein the determining a similarity value includes determining a similarity value based on the embedding and the added positional encoding.

22. The action recognition method of claim 14 further comprising selectively actuating an actuator of a robot in response to recognition of an action in the query video.

23. The action recognition method of claim 22 further comprising receiving the query video from a camera of the robot.

24. The action recognition method of claim 14 further comprising, in response to recognition of an action in the query video, selectively outputting at least one of a visual indicator and an audible indicator.

25. An action recognition method comprising:
by an action module trained to recognize performance of predetermined actions in videos, recognizing performance of the predetermined actions in videos;
determining a similarity matrix based on comparisons of (a) temporally ordered images of a query video with (b) temporally ordered images of a support videos,
the query video including performance of a new action that is not one of the predetermined actions, and
the support video including performance of the action;
by a similarity module including the transformer architecture, determining a similarity value for the support video based on the similarity matrix determined based on the query video and the support video; and
by the action module, setting a first indicator of the new action in the query video to the same as a second indicator of the action performed in the one of the support videos.
